(19) United States
(12) Patent Application Publication
(10) Pub. No.: US 2005/0160882 A1
(43) Pub. Date: Jul. 28, 2005

(54) Variable length socket

(76) Inventor: Wesley L. Crow, Troutville, VA (US)

Correspondence Address: Law Office;Dinesh Agarwal, P.C., Suite 330, 5350 Shawnee Road, Alexandria, VA, 22312, US

(21) Appl. No.: 10/761,266

(22) Filed: Jan. 22, 2004

(51) Int. Cl. B25B 23/16

(52) U.S. Cl. 81/177.2

(57) ABSTRACT

A variable length socket includes a first member with first and second sections and a second member for cooperating with the first member and including third and fourth sections. One of the first and second sections and one of the third and fourth sections include cooperating splines. The other of the first and second sections is configured to receive to a workpiece to be manipulated by the socket. The splines of the one of the first and second sections extend partly along the length of the first member.

### BACKGROUND OF THE INVENTION

The present invention is generally directed to hand tools, and more particularly to a variable length socket for use with a socket wrench, ratchet wrench, breaker bar, a tool handle, or the like.

Conventionally, a wrench is a hand tool typically used for holding and turning various workpieces, such as bolts, nuts, screws, pipes, spark plugs and the like. The prior art is replete with a variety of wrenches, including monkey wrenches, single-ended wrenches, double-ended wrenches, box wrenches and the like. Two commonly used wrenches include a socket wrench, which combines an offset handle with a male drive piece including a spring-loaded bearing lock on various sized sockets, and a ratchet wrench, which is a socket wrench having a ratchet mechanism that controls the clockwise or counterclockwise direction of an applied torque.

Wrenches are frequently used by mechanics, homebuilders, equipment manufacturers, homeowners, and other individuals in all sorts of applications and under all sorts of conditions. One of the most commonly visible application is by an automobile mechanic who uses a ratchet wrench to screw or unscrew various parts of an automobile, and particularly the engine. Another common application is by an individual homeowner, handyman or a repairman to use a socket or ratchet wrench to screw or unscrew various parts of, for example, a heating or air-conditioning unit, lawnmower, or the like. As the technology has advanced over the years, and particularly in the last decade, various equipment in various applications, and particularly automobile engines, have become more complex. This is particularly true for automobiles where an increasingly large number of parts and components are now being packed under the hood. Many parts are located in difficult-to-reach or in cramped locations. This makes proper application of torque rather difficult, if not impossible. This problem is further exacerbated if, for example, the ratchet wrench, and particularly the socket, is not long enough to properly reach the desired component.

Conventional socket wrenches include a lever arm having an end that engages a socket so as to turn or hold a bolt, nut, etc. Various length sockets are provided for manipulating different size bolts or to extend the length between the arm and the bolt. However, this requires the purchase and storage of a large number of various length sockets adding to the overall cost and the space needed for storage. Various other extensible wrenches are available, however, they include complicated locking mechanisms, etc.

Examples of various wrenches are disclosed in U.S. Pat. Nos. 1,417,683; 4,344,340; 4,856,388; 4,960,015; 5,138,911; 5,285,702; 5,363,727; 5,392,673; 5,471,899; 5,927,161; 6,038,946; and 6,408,721 B1. There is a need in the industry, however, for a variable length socket which is simple in design and construction and inexpensive to manufacture.

### OBJECTS AND SUMMARY OF THE INVENTION

The principal object of the present invention is to provide a variable length socket which overcomes the drawbacks associated with conventional wrenches and sockets.

An object of the present invention is to provide a variable length socket which is simple in design and construction and inexpensive to manufacture.

Another object of the present invention is to provide a variable length socket which easily extends the distance between a part being manipulated, such as a bolt or spark plug located in a hard-to-reach place, and the drive handle.

Yet another object of the present invention is to provide a variable length socket which can accommodate different size components, such as various length bolts or spark plugs, etc.

Still yet an additional object of the present invention is to provide a variable length socket which eliminates the need to purchase and store various length sockets.

An additional object of the present invention is to provide a variable length socket which can be used with a conventional socket or ratchet wrench handle, or a variable length ratchet wrench handle disclosed herein.

Yet an additional object of the present invention is to provide a variable length socket which is a simple, two-piece device that does not require a separate or complicated locking mechanism.

In summary, the main object of the present invention is to provide a variable length socket which is simple in design and construction, requires a minimum number of parts, easy to use, and is inexpensive to manufacture.

One of the above objects is met, in part, by the present invention, which in one aspect includes a variable length socket, including a first member with first and second sections, and a second member for cooperating with the first member and including third and fourth sections. One of the first and second sections and one of the third and fourth sections include cooperating splines. The other of the first and second sections is configured to receive to a workpiece to be manipulated by the socket. The splines of the one of the first and second sections extend partly along the length of the first member.

Another aspect of the present invention includes a variable length socket, including a first member with a spline section and an axially contiguous drive section, and a second member for telescopically cooperating with the first member and including a spline section and an axially contiguous drive section. The first member includes internal splines in the spline section thereof, and the second member includes external splines in the spline section thereof for cooperating with the internal splines of the first member. The internal splines extend upto about a midpoint along the length of the first member. The drive section of the first member includes an internal recess for receiving a workpiece to be manipulated by the socket.

### BRIEF DESCRIPTION OF THE DRAWINGS

One of the above objects, novel features and advantages of the present invention will become apparent from the following detailed description of the preferred embodiment(s) of the invention, as illustrated in the drawings, in which:

FIG. 1 is a perspective view of a variable length socket of the present invention shown in cooperation with a variable length ratchet wrench handle;

FIG. 2 is an enlarged sectional view taken along line 2-2 of FIG. 1;

FIG. 3 is an enlarged sectional view taken along line 3-3 of FIG. 1;

FIG. 4 is a view similar to FIG. 2, showing an alternative embodiment of the splines;

FIG. 5 is an exploded view of the variable length socket of the present invention shown in cooperation with a variable length ratchet wrench handle; and

FIG. 6 is an enlarged sectional view taken along line 6-6 of FIG. 5.

### DETAILED DESCRIPTION OF THE PREFERRED EMBODIMENT(S) OF THE INVENTION

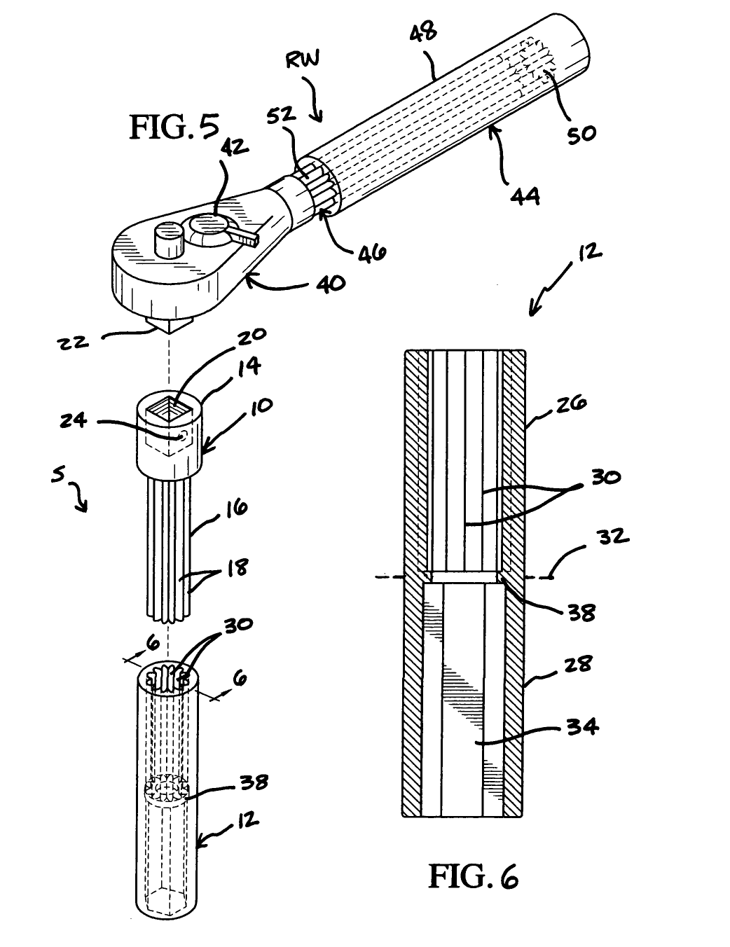

As best shown in FIGS. 1 and 5, the variable length socket S of the present invention includes a drive bar 10 which is telescopically received in a socket bar 12. The drive bar 10 includes an upper drive head 14 and a lower spline section 16. The spline section 16 includes preferably upto twenty-seven male splines 18. On the other hand, the upper drive head 14 includes a recess 20, which is preferably square in configuration, to receive a correspondingly-shaped drive member 22 of a ratchet wrench RW. The recess 20 includes one or more detents 24, preferably on all four sides thereof, for cooperation with the spring-biased balls (not shown) of the drive member 22. Preferably, the length of the spline section 16 is more than one-half of the total length of the drive bar 10.

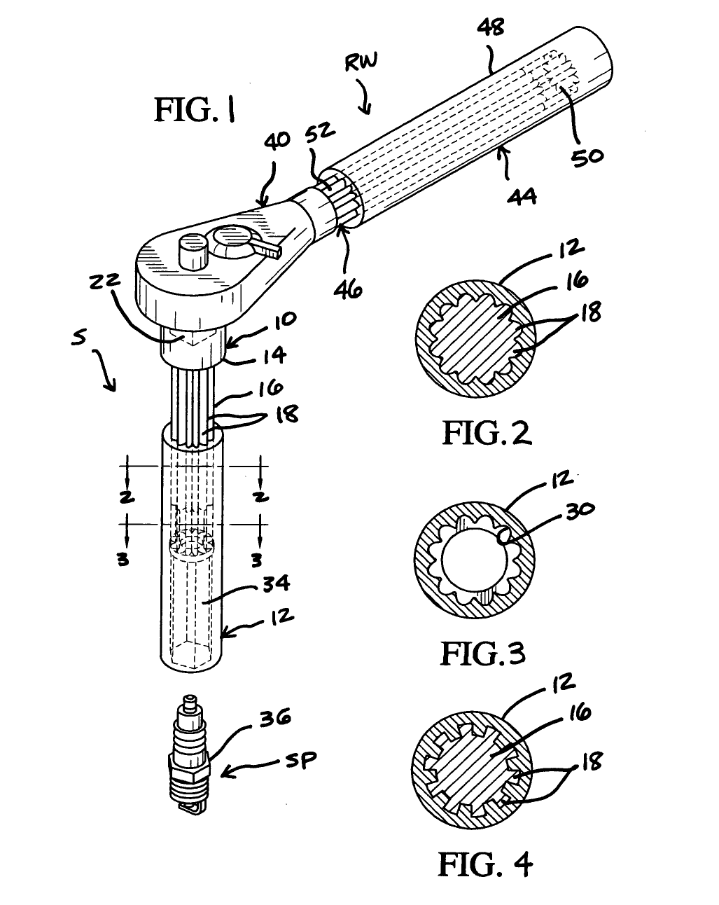

As best shown in FIG. 6, the socket bar 12 includes an upper spline section 26 and a lower axially contiguous drive section 28. The spline section 26 includes preferably upto twenty-seven female splines 30 that cooperate with the male splines 18 of the drive bar 10. Preferably, the splines 30 extend upto about (or slightly short of) a midpoint 32 along the length of the socket bar 12. The cooperating male and female splines 18 and 30 are generally involute or straight in shape (FIGS. 2-4), and preferably one-half to six inches in length. The male and female splines 18 and 30 are configured to have a tight clearance therebetween. This prevents significant rotational movement between the drive bar 10 and the socket bar 12, yet allows axial, frictional movement therebetween to vary the effective overall length of the socket S. In this manner, the splines 18 and 30 function to frictionally lock the drive bar 10 with the socket bar 12. (It is noted herewith that it is within the scope of the invention to vary the number, length, and/or shape or configuration of the cooperating male and female splines 18 and 30.)

The lower drive section 28 includes an internal recess 34 which is configured to receive a component to be manipulated by the socket S of the invention. For example, the recess 34 has been shown to be generally hexagonal in shape to hold and turn a spark plug SP (FIG. 1). To this end, the length of the recess 34 is selected so as to generally correspond to the length of the upper part of the spark plug SP in a manner that the hex nut 36 of the spark plug lockingly engages the recess 34 (FIG. 1). The length, and/or shape or configuration of the recess 34 may be varied, as desired, to accommodate other components to be manipulated by the variable length socket S of the present invention.

As best shown in FIG. 6, the upper spline section 26 and lower drive section 28 are separated by an internal, preferably circular, abutment 38 which functions as a stop for both the spline section 16 of the drive bar 10 and the spark plug SP, into upper spline section 26 and the recess 34, respectively. In other words, the abutment 38 prevents over-extension of the spline section 16 into the corresponding spline section 26, and over-extension of the component being manipulated by the socket S of the invention into the recess 34. (It is noted herewith that the abutment 38, although preferably circular, may take the form of one or more projections extending radially into the socket 12.)

The ratchet wrench RW includes a conventional front drive mechanism 40 with a lock 42 for changing the direction of the torque being applied. However, the ratchet wrench RW includes a variable length handle 44 for further making it easy to reach a component in a cramped or hard-to-reach location and improve the ability of a person to properly apply torque. As shown, the handle 44 includes a male spline section 46 telescopically received in a handle bar 48. The handle bar 48 includes female splines 50 which cooperate with the male splines 52 of the section 46. The splines 50 and 52 are preferably upto twenty-seven in number and involute or straight in shape. However, it is noted that it is within the scope of the invention to vary the number, length, and/or shape or configuration of the splines 50 and 52.

Use and Operaion

Although the use and operation of the variable length socket S and the variable length ratchet wrench RW of the invention, would be self-evident, a preferred manner of such is described with reference to hold and turn a spark plug. The socket bar 12 would first be placed over the spark plug SP (located in a hard-to-reach area) in a manner that the upper part of the spark plug is inserted all the way in the recess 34 and the hex nut 36 is frictionally, tightly engaged therein. The ratchet wrench RW would be held in a clear area and the drive bar 10 would then be locked therewith by inserting the drive member 22 into the recess 20 of the drive head 14. The spline section 16 of the drive bar 10 would then be inserted into the upper spline section 26 of the socket bar 12 to a desired distance therein so as to be able to manipulate the spark plug SP by rotating the ratchet wrench RW from the clear area. The effective length of the handle 44 of the ratchet wrench RW would likewise be adjusted by sliding in and out the male spline section 46 relative to the handle bar 48 to obtain a position or length that is easy and comfortable to apply a proper torque to the spark plug SP. The wrench handle 44 may then be rotated in a desired direction by first actuating the lock 42 to screw or unscrew the spark plug SP.

The socket S of the present invention can also be used, in the same manner, with a conventional ratchet wrench, breaker bar, tool handle, or the like, that does not have a variable length handle,

From the above, one can observe that the variable length socket S of the invention provides easy access to a component located in a hard-to-reach area with the enhanced ability to apply a proper torque thereto.

While this invention has been described as having preferred sequences, ranges, steps, materials, structures, features, and/or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the appended claims.

1. A variable length socket, comprising:
a) a first member including first and second sections;
b) a second member for cooperating with said first member and including third and fourth sections;
c) one of said first and second sections and one of said third and fourth sections including cooperating splines;
d) the other of said first and second sections configured to receive a workpiece to be manipulated by the socket;
e) the splines of said one of said first and second sections extending partly along the length of said first member.

2. The variable length socket of claim 1, wherein:
a) the splines of said one of said first and second sections extend upto about a midpoint along the length of said first member.

3. The variable length socket of claim 2, wherein:
a) the other of said first and second sections includes an internal recess extending upto about the midpoint along the length of said first member.

4. The variable length socket of claim 3, wherein:
a) said recess is generally hexagonal in shape.

5. The variable length socket of claim 2, wherein:
a) the splines are generally involute in shape.

6. The variable length socket of claim 2, wherein:
a) the splines are generally straight in shape.

7. The variable length socket of claim 2, wherein:
a) said one of said first and second sections includes six to twenty-seven splines.

8. The variable length socket of claim 2, wherein:
a) one of the splines of said one of said first and second sections is about one-half to six inches in length.

9. The variable length socket of claim 2, wherein:
a) the other of said third and fourth sections includes a recess for receiving a drive member of a wrench.

10. The variable length socket of claim 2, wherein:
a) the splines of said one of said third and fourth sections extend beyond a midpoint along the length of said second member.

11. The variable length socket of claim 1, in combination with a variable length wrench.

12. A variable length socket, comprising:
a) a first member including a spline section and an axially contiguous drive section;
b) a second member for telescopically cooperating with said first member and including a spline section and an axially contiguous drive section;
c) said first member including internal splines in said spline section thereof;
d) said second member including external splines in said spline section thereof for cooperating with the internal splines of said first member;
e) the internal splines extending upto about a midpoint along the length of said first member; and
f) said drive section of said first member including an internal recess for receiving a workpiece to be manipulated by the socket.

13. The variable length socket of claim 12, wherein:
a) said internal recess extends upto about the midpoint along the length of said first member.

14. The variable length socket of claim 12, wherein:
a) the internal and external splines are generally involute in shape.

15. The variable length socket of claim 12, wherein:
a) the internal and external splines are generally straight in shape.

16. The variable length socket of claim 12, wherein:
a) one of said first and second members includes six to twenty-seven splines.

17. The variable length socket of claim 12, wherein:
a) one of the internal splines and one of the external splines is about one-half to six inches in length.

18. The variable length socket of claim 12, wherein:
a) said drive section of said second member includes a recess for receiving a drive member of a wrench.

19. The variable length socket of claim 12, wherein:
a) the external splines extend beyond a midpoint along the length of said second member.

20. The variable length socket of claim 12, in combination with a variable length wrench.
